(19) United States
(12) Patent Application Publication
(10) Pub. No.: US 2025/0075118 A1
(43) Pub. Date: Mar. 6, 2025

(54) BIOSURFACTANTS FOR IRON AND ZINC SULFIDE SCALE REMEDIATION AND CONTROL

(71) Applicant: LOCUS SOLUTIONS IPCO, LLC, SOLON, OH (US)

(72) Inventors: AMIR MAHMOUDKHANI, SOLON, OH (US); HIN CHEONG AU YONG, SOLON, OH (US); KORTNEY TOOKER, SOLON, OH (US); RICHARD ARRIAGA, SOLON, OH (US)

(21) Appl. No.: 18/258,366

(22) PCT Filed: May 23, 2023
(86) PCT No.: PCT/US2023/067327

§ 371 Date: Jun. 20, 2023

Related U.S. Application Data
(60) Provisional application No. 63/345,174, filed on May 24, 2022.

(51) Int. Cl. C09K 8/528; C09K 8/32

(52) U.S. Cl. CPC C09K 8/528; C09K 8/32

(57) ABSTRACT

The subject invention provides scale inhibitors and/or dispersants comprising microbial surfactants, or biosurfactants, as well as methods of their use for removing metal sulfide scale deposits and/or preventing the precipitation and/or deposition thereof on the surfaces of, for example, reservoirs, wellbores, pipelines, tubing and other oilfield equipment.

### CROSS-REFERENCE TO RELATED APPLICATION

This application claims priority to U.S. provisional patent application No. 63/345,174, filed May 24, 2022, which is incorporated herein by reference in its entirety.

### BACKGROUND OF THE INVENTION

The safe and efficient production of oil and gas depends on the proper functioning of hydrocarbon-producing facilities. One of the most common issues leading to structural failure and production inefficiency within facilities is the accumulation of deposits in the formation, as well as in and around the wellbore, tubing, flow lines, storage tanks, separators, and other components of oil and gas production infrastructure.

These problematic deposits can be formed by, for example, deposits of precipitated mineral salts, which can arise as a result of, for example, changes in the pressure, composition and/or temperature of the crude oil. Scales can result from precipitates of, for example, barium sulfate, calcium carbonate, strontium sulfate, calcium sulfate, sodium chloride, silicon dioxide, iron sulfide, iron oxides, iron carbonate, silicates, phosphates and oxides, or any of a number of compounds that are insoluble or mildly soluble in water.

Systematic inhibition or removal of deposits is crucial to maintaining properly functioning oil and gas producing facilities. Once even a thin layer of a deposit forms on a surface, such as in a formation pore throat, the rate of further accumulation drastically increases. Furthermore, as an oil well ages, deposits become more prevalent due to changes in the environment within the formation and the well. For example, as reservoir pressure drops, oil production decreases, which in turn decreases flow rates. The slowing of flow rates can lead to the buildup of organic deposits in the pores of the formation, thus reducing hydrocarbon movement into the wellbore. This can lead to changes in temperature gradients and thus even greater precipitation of deposits, including scale. Thus, the effects are interrelated, cyclical and compounding, unless they are dealt with consistently.

Iron and zinc sulfide scales have been found in several fields in onshore and offshore oil and gas wells and are often associated with formations containing native sulfide deposits and sour reservoir fluids. Scale deposition can cause significant pressure and rate reductions in high-temperature and high-rate gas, condensate, and black oil wells. Metal oxides and carbonate are also commonly found alongside sulfides, causing them to be the most challenging scales to inhibit and/or remove.

Acidizing and squeezing scale inhibitors are often used as remediation and prevention treatments. Although there has been some success in development of sulfide scale inhibitors, significantly high concentrations of inhibitor are often required to have a mitigating effect, especially for zinc sulfide. There are three mechanisms for iron sulfide scale inhibition in aqueous solution: 1) threshold inhibition (inhibitor blocks the growth sites); 2) crystal modification (inhibitor distorts the crystalline lattice shape); and 3) dispersion (inhibitor prevents the agglomeration due to repulsive electrostatic charges).

Sulfide scale inhibitors commonly utilize small molecules or polymeric compounds comprising carboxylate, amide, and phosphino/phosphonate functional groups, while compositions for sulfide control often includes surfactants. Surfactants are used to improve fluid compatibility, break emulsions, and change surface properties to enhance interactions of inhibitor chemistry with sulfide scale. Despite ongoing research into these technologies, fulfide scale solids are preferentially oil-wet and can be easily coated with hydrocarbons, which can act as a barrier to acids and inhibitors.

One area of further research in metal sulfide scale management and control could be microbial-derived surfactants, or biosurfactants, which are biobased and offer some unique functionalities when compared to other bio-based and petroleum-based surfactants, thanks to their complex structure and diversity. A biosurfactant typically consists of lipid, protein, and/or carbohydrate moieties and are frequently associated with cell walls or membranes of microorganisms. More specifically, biosurfactants are divided into four main categories: phospholipids, glycolipids, lipopeptides, and polymeric molecules. Glycolipids represent a major sector of the biosurfactant market that include sophorolipids, rhamnolipids, and mannosylerythritol lipids.

Despite the small amount of the surfactant market that is currently represented by biosurfactants, there is an increasing interest in microbial biosurfactants for several reasons. First, biosurfactants are considered environmentally friendly, because they are relatively nontoxic and readily biodegradable. Second, biosurfactants have unique structures that are just beginning to be appreciated for their potential applications in many different facets of industry, including agriculture, food, pharmaceutical, household cleanings and oil & mining. Additionally, most biosurfactants are currently produced at industrial scale by fermentation techniques using microorganisms that can be found in nature. Thanks to advancements in bioinformatics and applied microbiology, fermentation processes have been improved to produce biosurfactants at high yield and quality, making them economically viable for several industrial applications that require specialty compounds.

Because of the importance of safe and efficient oil and gas production and the difficulties caused by scale deposits in production and transport of oil and gas, there is a continuing need for improved methods of inhibiting, and/or removing such deposits from, hydrocarbon-producing facilities. Biosurfactants could be a useful tool in meeting this need.

### BRIEF SUMMARY OF THE INVENTION

The subject invention provides environmentally-friendly, non-toxic compositions and methods for improving oil and gas production from an oilfield. Specifically, the subject invention provides scale inhibitors and/or dispersants comprising microbial surfactants, or biosurfactants, as well as methods of their use for removing metal sulfide scale deposits and/or preventing the precipitation and/or deposition thereof on the surfaces of, for example, reservoirs, wellbores, pipelines, tubing and other oilfield equipment.

Advantageously, in some embodiments, the subject treatments can free clogged pores, channels and/or tubing, and/or reduce the capillary pressure in a formation, thus allowing for increased oil production from depleted wells, and further, even allowing inoperable wells to resume operation. Additionally, through a variety of mechanisms, the subject treatments can stimulate wells, improve the quality of crude oil, and help in the maintenance of oil production and processing equipment.

In preferred embodiments, the subject invention provides methods for remediating and/or inhibiting metal sulfide scale deposits in an oil production environment, wherein a scale inhibitor composition comprising a microbial-derived biosurfactant is contacted with a fluid and/or with a surface present in the oil production environment having scale therein or thereon. In certain embodiments, the scale is a sulfide scale, such as iron sulfide and/or zinc sulfide, or an ionic portion thereof.

In certain embodiments, the scale inhibitor composition is applied to a subterranean formation, an oil and/or gas well, a wellbore, and/or equipment associated therewith in order to inhibit deposition of sulfide scale on such surfaces. For example, the methods can be useful for preventing precipitation and/or deposition of sulfide scale in the rock pores of subterranean formations, in oil wells, in wellbores, and on equipment, such as, for example, tubing, pipes, valves, drills and tanks associated with all aspects of oil and/or gas production. This can be achieved via, for example, threshold inhibition and/or crystal modification.

In certain embodiments, the compositions is applied to fluids and/or to a subterranean formation to disperse scale ions and/or to maintain suspension of scale ions in the fluids so as to reduce agglomeration and/or precipitation thereof and thus, prevent formation of deposits on surfaces. In certain embodiments, the compositions and methods are used for remediating, or removing, scale deposits that have formed on surfaces within an oil production environment.

The biosurfactants utilized according to the subject invention can comprise one or more glycolipids such as, for example, rhamnolipids (including mono- and di-rhamnolipids), rhamnose-d-phospholipids, trehalose lipids, trehalose dimycolates, trehalose monomycolates, mannosylerythritol lipids, cellobiose lipids, ustilagic acids and/or sophorolipids (including lactonic forms and/or linear forms). In one embodiment, the biosurfactants comprise one or more lipopeptides, such as, for example, surfactin, iturin, fengycin, arthrofactin, viscosin, amphisin, syringomycin, and/or lichenysin.

In certain preferred embodiments, the biosurfactants are glycolipids selected from sophorolipids and rhamnolipids.

The biosurfactants can be purified and/or they can be utilized in crude form, wherein the crude form comprises microbial cells, fermentation broth and/or nutrients that are residual from fermentation. If present, the microbial cells are preferably inactivated prior to use by, for example, heat inactivation.

In certain embodiments, the composition can further comprise other substances that are useful for removing, inhibiting and/or dispersing sulfide scales, and/or that are useful for enhancing oil recovery, such as, for example, solvents, non-biological surfactants, enzymes, polymers, and/or chelating agents. Preferably, however, the additional substances are non-toxic and/or biodegradable.

In some embodiments, the subject compositions and methods result in enhanced oil recovery through, for example, dissolution and/or dispersal of scale deposits that have plugged rock pore throats in a formation; prevention and/or reduction of scale agglomeration in oil or other fluids, and/or deposition thereof on equipment surfaces; increase in the mobility of crude oil during recovery; stimulation of the flow of oil from an oil well; and increase in the wettability of formation rock.

In certain embodiments, the subject invention can be used for improving, enhancing, and/or maintaining oil recovery from, and operation of, for example, subterranean formations, oil and/or gas wells, boreholes, tubes, pipes, drills, tanks and other structures and equipment involved in oil and/or gas production, transportation, storage and refining. The subject invention can be used in, for example, vertical, horizontal and/or fracking wells, mature wells, stripper (marginal) wells, flowlines, to clean near wellbore zones and to clean storage tanks.

Advantageously, in some embodiments, the compositions and methods of the subject invention are more effective than traditional surfactants with regard to scale inhibition and/or remediation. Additionally, the subject compositions and methods can be used alongside and/or to enhance or supplement other methods of scale inhibition and/or dispersal, as well as other microbial, mechanical, thermal and/or chemical treatments utilized in EOR.

Furthermore, the subject compositions and methods can be used without releasing large quantities of inorganic compounds into the environment, and can utilize components, such as biosurfactants, that are biodegradable and toxicologically safe. Thus, while the subject invention can utilize non-biological or synthetic chemical components, the present invention can also be formulated as an environmentally-friendly treatment.

### BRIEF DESCRIPTION OF THE DRAWINGS

FIGS. 1A-1D show general structures of biosurfactants according to embodiments of the subject invention, where a) is surfactin; b) is a sophorolipid; c) is a rhamnolipid; and d) is a mannosylerythritol lipid.

FIGS. 2A-2C show the chemical structures of surfactants utilized according to embodiments of the subject invention, where a) shows linear sophorolipids having varying degrees of saturation in the fatty acid moiety; b) shows (from left to right) a di-rhamnolipid and a mono-rhamnolipid; and c) shows Triton X-100.

FIG. 3 shows FTIR spectra for the surfactants described in FIG. 2, wherein the sophorolipids comprise a mixture of the three sophorolipid structures shown in FIG. 2; and wherein the rhamnolipids comprise a mixture of the two rhamnolipid structures shown in FIG. 2.

FIG. 4 shows static surface tension of the surfactants described in FIG. 2 as a function of active concentration, wherein the sophorolipids comprise a mixture of the three sophorolipid structures shown in FIG. 2; and wherein the rhamnolipids comprise a mixture of the two rhamnolipid structures shown in FIG. 2.

FIG. 5 shows a comparison of static versus dynamic surface tension of the surfactants described in FIG. 2 as a function of active surfactant concentration at pH 7, wherein the sophorolipids comprise a mixture of the three sophorolipid structures shown in FIG. 2; and wherein the rhamnolipids comprise a mixture of the two rhamnolipid structures shown in FIG. 2.

FIG. 6 shows interfacial tension (IFT) of dodecane-water droplet as a function of time in the presence of the surfactants shown in FIG. 2.

FIG. 7 shows images of how contact angle measurement is conducted on a pyrite surface.

FIG. 8 shows images captured by high-speed camera showing droplet evolvement on the surface of pyrite for distilled water, rhamnolipids and Triton X-100.

FIG. 9 shows the contact angle measured over time for DI water and the surfactants described in FIG. 2, at 250 ppm concentration.

FIG. 10 shows images of LUMiSizer cells with settled or suspended FeS and ZnS particulates compared with untreated cells.

FIG. 11 shows the evolution of transmission profiles and separation index for lab-made FeS.

FIG. 12 shows the evolution of transmission profiles and separation index for lab-made ZnS.

FIG. 13 shows the evolution of transmission profiles and separation index for a field sample containing ZnS/FeS.

FIG. 14 shows FTIR spectra of solids precipitated in the presence of the surfactants shown in FIG. 2 compared with neat surfactants.

FIG. 15 shows UV-vis spectra of aqueous solutions of iron (III) chloride in the presence of surfactants.

FIG. 16 shows a schematic representation of modes of action for sophorolipids with FeS and ZnS through metal coordination and chelation.

### DETAILED DESCRIPTION

The subject invention provides environmentally-friendly, non-toxic compositions and methods for improving oil and gas production from an oilfield. Specifically, the subject invention provides scale inhibitors and/or dispersants comprising microbial surfactants, or biosurfactants, as well as methods of their use for removing metal sulfide scale deposits and/or preventing the precipitation and/or deposition thereof on the surfaces of, for example, reservoirs, wellbores, valves, pipelines, tubing and other oilfield equipment.

### Selected Definitions

As used herein, “scale” is a deposit caused by the precipitation and accumulation of crystals that occurs when a fluid becomes saturated with ionic species that form micro-aggregates. Scale can be organic, such as paraffin wax, asphaltene and/or gas hydrates; as well as inorganic, which include mineral deposits resulting from the precipitation of, for example, barium sulfate, calcium carbonate, calcium sulfate, calcium oxalate, magnesium hydroxide, magnesium oxide, silicates, strontium sulfate, aluminum oxide hydroxides, aluminosilicates, magnetite or nickel ferrite, sodium chloride, silicon dioxide, iron sulfide, iron oxides, iron carbonate, copper, phosphates, and oxides. In certain specific embodiments, the scale is a metal sulfide scale, such as iron sulfide or zinc sulfide.

As used herein, “prevention” means avoiding, delaying, forestalling, inhibiting or minimizing the onset or progression of an occurrence or situation. Prevention can include, but does not require, absolute or complete prevention, meaning the occurrence or situation may still develop at a later time and/or with a lesser severity than it would without preventative measures. Prevention can include reducing the severity of the onset of an occurrence or situation, and/or inhibiting the progression thereof to one that is more severe. A scale “inhibitor” is an agent that prevents the precipitation of scale from a fluid and/or accumulation thereof onto surfaces. Scale inhibitors are generally organic compounds containing sulphonate, phosphate or carboxylic acid functional groups and/or chelating agents such as carbon, alum and zeolites that sequester and neutralize ions.

As used herein, reference to a “microbe-based composition” means a composition that comprises components that were produced as the result of the growth of microorganisms or other cell cultures. Thus, the microbe-based composition may comprise the microbes themselves and/or by-products of microbial growth. Preferably, the compositions according to the subject invention comprise inactivated microbes, or have been separated from the microbes altogether. The by-products of microbial growth may be, for example, metabolites (e.g., biosurfactants), cell membrane components, expressed proteins, and/or other cellular components.

The subject invention further provides “microbe-based products,” which are products that are to be applied in practice to achieve a desired result. The microbe-based product can be simply the microbe-based composition harvested from the microbe cultivation process. Alternatively, the microbe-based product may comprise further ingredients that have been added. These additional ingredients can include, for example, stabilizers, buffers, appropriate carriers, such as water, salt solutions, or any other appropriate carrier, added nutrients to support further microbial growth, non-nutrient growth enhancers, and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

As used herein, an “isolated” or “purified” nucleic acid molecule, polynucleotide, polypeptide, protein or organic compound, such as a small molecule, is substantially free of other compounds, such as cellular material, with which it is associated in nature. In certain embodiments, purified compounds are at least 60% by weight the compound of interest. Preferably, the preparation is at least 75%, more preferably at least 90%, and most preferably at least 99%, by weight the compound of interest. For example, a purified compound is one that is at least 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

Ranges provided herein are understood to be shorthand for all of the values within the range. For example, a range of 1 to 20 is understood to include any number, combination of numbers, or sub-range from the group consisting 1, 2, 3, 4, 5, 6, 7, 8, 9, 10, 11, 12, 13, 14, 15, 16, 17, 18, 19 and 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein, “reduces” means a negative alteration of at least 1%, 5%, 10%, 25%, 50%, 75%, or 100%.

As used herein, “reference” means a standard or control condition.

A “metabolite” refers to any substance produced by metabolism (e.g., a growth by-product) or a substance necessary for taking part in a particular metabolic process. A metabolite can be an organic compound that is a starting material (e.g., glucose), an intermediate (e.g., acetyl-CoA) in, or an end product (e.g., n-butanol) of metabolism. Examples of metabolites include, but are not limited to, biosurfactants, enzymes, acids, solvents, gasses, alcohols, proteins, vitamins, minerals, microelements, amino acids, and polymers.

As used herein, “surfactant” means a compound that lowers the surface tension (or interfacial tension) between two liquids or between a liquid and a solid. Surfactants act as, e.g., detergents, wetting agents, emulsifiers, foaming agents, and/or dispersants. A “biosurfactant” is a surface-active substance produced by a living cell and/or derived from naturally-occurring substrates.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Microbial Surfactants to Remediate Scale

The subject invention provides environmentally-friendly, non-toxic compositions and methods for improving oil and gas production from an oilfield. Specifically, the subject invention provides scale inhibitor compositions comprising microbial surfactants, or biosurfactants, as well as methods of their use for preventing the agglomeration, flocculation, precipitation and/or deposition of metal sulfide scales on the surfaces of, for example, reservoirs, wellbores, valves, pipelines, and other oilfield equipment. In certain embodiments, the compositions and methods can also remediate or dissolve scale deposits, enhance oil recovery, as well as improve one or more properties of crude oil.

In preferred embodiments, the subject invention provides methods for remediating and/or inhibiting metal sulfide scale deposits in an oil and/or gas production environment, wherein a scale inhibitor composition comprising a microbial-derived biosurfactant is contacted with a fluid and/or with a surface in the oil and/or gas production environment where scale ions and/or scale deposits are present. In certain embodiments, the scale is a sulfide scale, such as iron sulfide and/or zinc sulfide. The fluids can be, for example, crude oil fluids, brine fluids, produced water, fracking fluids, or other well treatment fluids utilized in oil and gas recovery.

In certain embodiments, the compositions and methods can be useful for preventing precipitation and/or deposition of sulfide scale in the rock pores of subterranean formations, in formation fractures, and on equipment, such as, for example, tubing, pipes, pipelines, drills, pumps, valves and tanks associated with all aspects of oil and/or gas production. This can be achieved via, for example, threshold inhibition and/or crystal modification.

In certain embodiments, the compositions and methods can be useful for dispersing scale ions, and/or for maintaining suspension of scale ions and crystals in a fluid so as to reduce agglomeration and/or precipitation thereof and thus, prevent formation of deposits.

In certain embodiments, the compositions and methods function surprisingly better than chemical surfactants, such as, for example, Triton X-100. Thus, in one embodiment, the subject invention can replace, or reduce the amount used of, compositions that utilize synthetic or chemical scale dispersants and inhibiters for preventing agglomeration, flocculation, precipitation and/or deposition of scale. Furthermore, the subject methods can reduce or replace the need for physical alteration of equipment to prevent scale agglomeration, flocculation, precipitation and/or deposition.

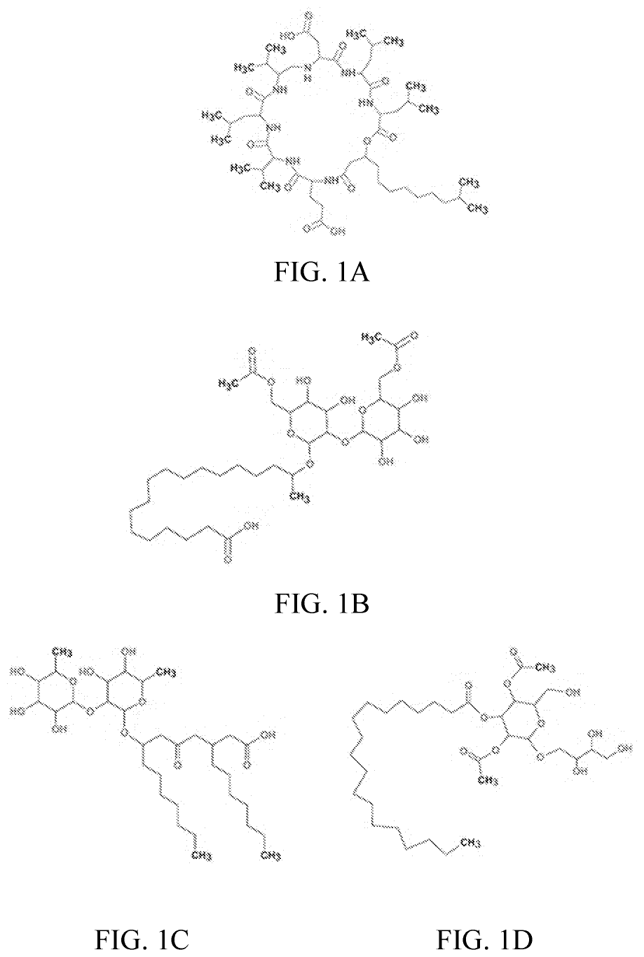

The biosurfactants utilized according to the subject invention can be one or more glycolipids such as, for example, rhamnolipids, rhamnose-d-phospholipids, trehalose lipids, trehalose dimycolates, trehalose monomycolates, mannosylerythritol lipids, cellobiose lipids, ustilagic acids and/or sophorolipids. In one embodiment, the biosurfactants comprise one or more lipopeptides, such as, for example, surfactin, iturin, fengycin, arthrofactin, viscosin, amphisin, syringomycin, and/or lichenysin. FIG. 1.

In certain preferred embodiments, the biosurfactants are glycolipids selected from sophorolipids and rhamnolipids.

In certain embodiments, the scale inhibitor composition comprises components that were produced as the result of the growth of microorganisms or other cell cultures. Thus, the composition may comprise the microbes themselves and/or by-products of microbial growth. In some embodiments, the glycolipids are purified from the cell culture. In some embodiments, they are utilized in crude form, wherein the crude form comprises residual cells, fermentation broth, growth by-products, and/or nutrients from fermentation. The microbes may be in a vegetative state, in spore form, in mycelial form, in any other form of propagule, or a mixture of these. The microbes may be planktonic or in a biofilm form, or a mixture of both. The by-products of growth may be, for example, metabolites, cell membrane components, expressed proteins, and/or other cellular components. The microbes may be intact or lysed, active or inactive. In some embodiments, the microbes are present, with medium in which they were grown, in the composition. The microbes may be present at, for example, a concentration of 1×10⁴, 1×10⁵, 1×10⁶, 1×10⁷, 1×10⁸, 1×10⁹, 1×10¹⁰, 1×10¹¹, 1×10¹², or 1×10¹³ (or any concentration there-between) or more CFU per milliliter of the composition. If present, the microbe cells are preferably inactivated prior to use by, for example, heat inactivation.

In certain embodiments, use of fermentation products according to the subject invention can be superior to, for example, purified microbial metabolites alone, due to, for example, the advantageous properties of the microbial cell walls. These properties include high concentrations of mannoprotein as a part of yeast cell wall's outer surface (mannoprotein is a highly effective bioemulsifier) and the presence of biopolymer beta-glucan (also an effective emulsifier) in yeast cell walls. Additionally, the fermentation product can further comprise biosurfactants capable of reducing both surface and interfacial tension, enzymes and other metabolites (e.g., lactic acid, ethyl acetate, ethanol, etc.) that are capable of solubilizing deposit compounds.

In certain embodiments, the glycolipid biosurfactant is a sophorolipid (SLP). Sophorolipids are glycolipid biosurfactants produced by, for example, various yeasts of the Starmerella clade when cultivated in the presence of a hydrocarbon-based source of one or more fatty acids. SLP typically consist of a disaccharide sophorose linked to long chain hydroxy fatty acids. They can comprise a partially acetylated 2-O-β-D-glucopyranosyl-D-glucopyranose unit attached β-glycosidically to 17-L-hydroxyoctadecanoic or 17-L-hydroxy-Δ9-octadecenoic acid. The hydroxy fatty acid is generally 16 or 18 carbon atoms, and may contain one or more unsaturated bonds. Furthermore, the sophorose residue can be acetylated on the 6- and/or 6′-position(s). The fatty acid carboxyl group can be free (acidic or linear form (General Formula 2)) or internally esterified at the 4″-position (lactonic form (General Formula 1)). S. bombicola produces a specific enzyme, called S. bombicola lactone esterase, which catalyzes the esterification of linear SLP to produce lactonic SLP.

In preferred embodiments, the SLP according to the subject invention are represented by General Formula (1) and/or General Formula (2), and are obtained as a collection of 30 or more types of structural homologues:

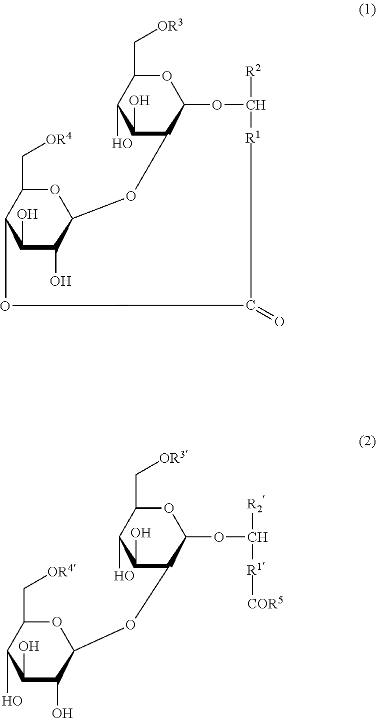

where R¹ and R¹′ independently represent saturated hydrocarbon chains or single or multiple, in particular single, unsaturated hydrocarbon chains having 8 to 20, in particular 12 to 18 carbon atoms, more preferably 14 to 18 carbon atoms, which can be linear or branched and can comprise one or more hydroxy groups, R² and R²′ independently represent a hydrogen atom or a saturated alkyl functional group or a single or multiple, in particular single, unsaturated alkyl functional group having 1 to 9 carbon atoms, more preferably 1 to 4 carbon atoms, which can be linear or branched and can comprise one or more hydroxy groups, and R³, R³′, R⁴ and R⁴′ independently represent a hydrogen atom or —COCH₃.

The composition utilized according to the subject methods can comprises more than one form of SLP, including linear SLP and lactonic SLP. The SLP can be non-acetylated, mono-acetylated and/or di-acetylated SLP.

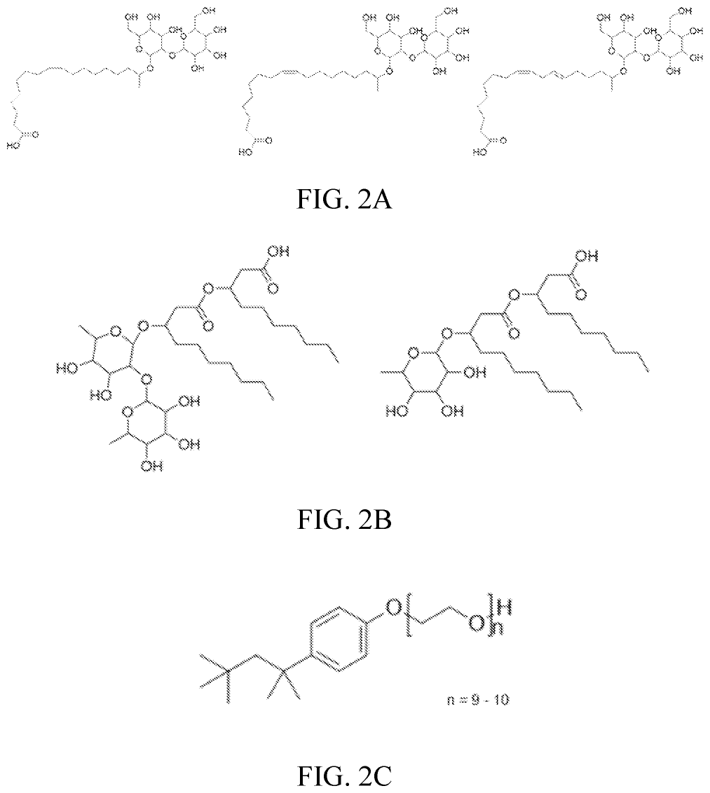

In certain specific embodiments, the composition comprises SLP according to General Formula (1) (linear SLP) wherein R1 and/or R2 are an acetyl group, and wherein R3 is derived from a stearic, oleic and/or linoleic fatty acid. In certain embodiments, a mixture of these forms is utilized. FIG. 2.

In certain embodiments, the glycolipid is a rhamnolipid. Rhamnolipids comprise a glycosyl head group (i.e., a rhamnose) moiety, and a 3-(hydroxyalkanoyloxy)alkanoic acid (HAA) fatty acid tail, such as, e.g., 3-hydroxydecanoic acid. Two main subtypes of rhamnolipids exist, mono- and di-rhamnolipids, which comprise one or two rhamnose moieties, respectively. The HAA moiety can vary in length and degree of branching, depending on, for example, the growth medium and the environmental conditions. The highest accumulation of rhamnolipids (RLP) has been shown by submerged cultivation of Pseudomonas spp., such as P. aeruginosa.

Rhamnolipids according to the subject invention can have the following structure, according to General Formula (3):

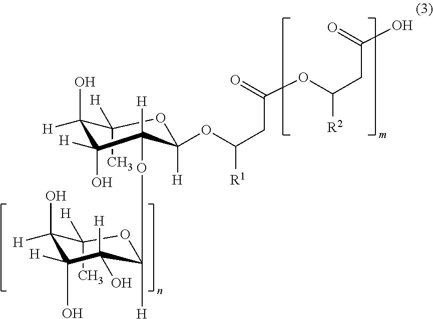

wherein m is 2, 1 or 0,
n is 1 or 0,
R¹ and R² are, independently of one another, the same or a different organic functional group having 2 to 24, preferably 5 to 13 carbon atoms, in particular a substituted or unsubstituted, branched or unbranched alkyl functional group, which can also be unsaturated,
wherein the alkyl functional group is a linear saturated alkyl functional group having 8 to 12 carbon atoms, or is a nonyl or a decyl functional group or a mixture thereof.

Salts of these compounds are also included according to the invention. In the present invention, the term “di-rhamnolipid” is understood to mean compounds of the above formula or the salts thereof in which n is 1. Accordingly, “mono-rhamnolipid” is understood in the present invention to mean compounds of the general formula or the salts thereof in which n is 0. In certain specific embodiments, the composition comprises a mixture of mono- and di-rhamnolipids. FIG. 2.

In some embodiments, the subject compositions have enhanced scale remediation properties over chemical or synthetic surfactants due to the small size of the glycolipid biosurfactants and/or micelles formed by the biosurfactants. The small size of the micelles allows for penetration of the composition into nano-sized spaces and pores on surfaces that may otherwise be passed over by larger-sized synthetic materials. For example, in some embodiments, the size of the glycolipid biosurfactant micelle is less than 500 nm, preferably less than 100 nm, and more preferably, less than 5 nm. In one example, the glycolipid has a micelle size of 1 nm to 5 nm.

In preferred embodiments, the biosurfactants are isolated from the microbial culture in which they were produced and purified to at least 90%, more preferably at least 92% purity. In certain embodiments the concentration of the biosurfactant(s), either individually or combined, is at or above minimum inhibitory concentration, which can range from about 0.5 ppm to about 20,000 ppm, about 5 ppm to about 15,000 ppm, about 10 ppm to about 10,000 ppm, about 100 ppm to about 600 ppm, or about 1 to 20 ppm, relative to the total fluid being applied and/or treated.

In certain embodiments, the composition can further comprise other substances that are useful for inhibiting and/or dispersing scale, and/or that are useful for enhancing oil recovery, such as, for example, solvents, non-biological surfactants, organic acids, biocides, enzymes, polymers, and/or chelating agents. Preferably, however, the additional substances are non-toxic and/or biodegradable. These additional compounds can be added in amounts ranging from, for example, 0.0001% to 20%, 0.001% to 30%, 0.01% to 40%, or 0.1% to 50% (or greater), by weight or volume relative to the total fluid being applied and/or treated.

In an exemplary embodiment, the composition comprises the biosurfactant(s) and one or more organic acids. In another exemplary embodiment, the composition comprises the biosurfactant(s) and one or more non-biological surfactants. In another exemplary embodiment, the composition comprises the biosurfactant(s) and one or more biocides. In another exemplary embodiment, the composition comprises the biosurfactant(s) and one or more solvents. In another exemplary embodiment, the composition comprises the biosurfactant(s) and any combination of: one or more organic acids, one or more biocides, one or more solvents and one or more non-biological surfactants.

In some embodiments, the composition comprises a solvent selected from, for example, terpenes and/or terpenoids (e.g., limonenes, orange terpenes, lemon terpenes, grapefruit terpenes, orange oil, lemon oil, other citrus terpenes, other citrus oils, geraniol, terpineol, dipentene, myrcene, linalool, cymene and pinene), alcohols (e.g., ethanol, methanol, propanol, isopropyl alcohol and/or hexanol), ionic or semi-ionic liquids, acetates (e.g., isoamyl acetate and/or primary amyl acetate), aliphatic and/or aromatic hydrocarbons, olefins, esters, oxygenates, ketones, acetic acid, kerosene, gasoline, diesel, benzene, ethyl benzenes, propyl benzenes, butyl benzenes, hexane, toluene, ethyl toluenes, xylene, alkylene amines, carbon disulfide, mesitylene, cumene, cymenes, saturated aliphatic and/or alicyclic hydrocarbons, naphtha, naphthenes, decalin, tetralin, turpentine, carbon tetrachloride, ether alcohol, pinene, dialkyl ether and/or any combination thereof.

In some embodiments, the composition comprises an organic acid selected from, for example, acetic acid, citric acid, formic acid, lactic acid, malic acid, oxalic acid, tartaric acid, uric acid, propionic acid, butyric acid, sorbic acid, fumaric acid, benzoic acid, hydrofluoric acid, caproic acid, salicylic acid, gluconic acid, pyruvic acid, adipic acid, trichloroacetic acid, glycolic acid, cinnamic acid, carboxylic acids, succinic acid, carbonic acid, glutaric acid, decanoic acid, and ascorbic acid. In some embodiments, the composition comprises an inorganic acid selected from, for example, hydrochloric acid, sulfuric acid, nitric acid, phosphoric acid, boric acid, perchloric acid, hydrofluoric acid, hydrobromic acid, and sulfonic acid.

In some embodiments, the composition comprises a biocide selected from, for example, chlorine, chlorine dioxide, hydrogen peroxide, bromine, ozone, quaternary ammonium compounds, bronopol, tetrakis hydroxymethyl phosphonium sulfate (THPS), DBNPA and gluteraldehyde.

In some embodiments, an ionic or semi-ionic liquid can be included in the composition. Exemplary ionic or semi-ionic liquids suitable for the subject composition include, but are not limited to, ethyl ammonium nitrate, and/or a semi-ionic mixture of glycerin/glycerol with magnesium sulfate heptahydrate (MgSO₄·7H₂O)). In one embodiment, the mixture of glycerol and Epsom salt (MgSO₄·7H₂O) has a ratio of glycerol to Epsom salt of 1:1 to 1:10, or from 1:1 to 10:1.

The subject composition can further comprise one or more ammonium-based compounds. In some embodiments, the ammonium compounds are selected from ammonium phosphate, monoammonium phosphate (or ammonium dihydrogen phosphate) and ammonium hydroxide.

In some embodiments, the composition further comprises one or more chelating agents. As used herein, “chelator” or “chelating agent” means an active agent capable of removing a metal ion from a system by forming a complex so that the metal ion, for example, cannot readily participate in or catalyze oxygen radical formation.

Examples of chelating agents include, but are not limited to, dimercaptosuccinic acid (DMSA), 2,3-dimercaptopropanesulfonic acid (DMPS), alpha lipoic acid (ALA), thiamine tetrahydrofurfuryl disulfide (TTFD), penicillamine, ethylenediaminetetraacetic acid (EDTA), sodium acetate, sodium citrate and citric acid.

### Application of the Composition

In certain embodiments, the composition is applied to, e.g., a subterranean formation, an oil and/or gas well, crude oil, brine fluids, a wellbore, and/or equipment associated therewith in order to prevent agglomeration, flocculation, precipitation and/or deposition of scales on such surfaces. In certain embodiments, the composition is applied to surfaces to remediate scale deposits.

Thus, in certain embodiments, the methods are useful for reducing the various problems that can arise from scale deposits in oil wells, in wellbores, and on equipment, such as, for example, tubing, pipes, drills, tanks, valves, flowlines, rods, pumps, casings, and/or other surfaces or materials associated with all aspects of oil and/or gas production. The subject invention can be used in, for example, vertical, horizontal and/or fracking wells, mature wells, stripper (marginal) wells, offshore wells, in flowlines, to clean near-wellbore zones and to clean storage tanks.

As used herein, “applying” a composition or product refers to contacting it with a target or site such that the composition or product can have an effect on that target or site. This can be achieved by any means, for example, the compositions can be pumped or injected into oil wells and/or the wellbores as a continuous injection treatment, a batch treatment and/or as a squeeze treatment, run through piping, pumps and valves, and/or sprayed onto the inside of tanks. The composition can be applied directly to the surfaces of oil and gas equipment, and or mixed into crude fluids, brine fluids, frack fluids and/or other well treatment fluids.

In some embodiments, the treatment of an oil production environment, either during the recovery, transportation, processing and/or refining of oil, with an effective amount of the composition, disperses and/or maintains dispersion of scale molecules, thereby preventing or reducing agglomeration, flocculation, precipitation, and/or the build-up of scale deposits in rock formations and equipment that is designed for, e.g., storing, handling, pumping, transporting, or refining crude oils or fractions thereof. This treatment may be achieved at temperatures as low as −10° C. up to temperatures exceeding 500° C.′, or about 1° C. to 400° C.

In one embodiment, application of a composition of the subject invention can be performed during drilling operations (e.g., while drilling, while tripping-in or tripping-out of the hole, while circulating mud, while casing, while placing a production liner, and/or while cementing, etc.), and/or as a production treatment (e.g., after oil and/or gas recovery is underway).

Furthermore, the subject invention can be applied during all stages of the chain of operations, including exploration and production operators (e.g., onshore and offshore wellbores, flowlines, formations, and tanks), midstream (e.g., pipelines, tankers, transportation and storage tanks), and in refineries (e.g., heat exchangers, furnaces, distillation towers, cokers, and hydrocrackers).

As an exemplary embodiment, the composition can be applied in a batch or continuous injection through a capillary line, down the backside of the well annulus, through an umbilical line, or through an umbilical/capillary line combination. In one embodiment, the composition can be applied as a squeeze treatment.

In some embodiments, the methods are implemented once scale precipitation and/or deposition has begun, and/or after the rate of oil production from a well has begun to decline.

In certain embodiments the composition is applied upstream of the location where scale onset pressure occurs, for example, downhole. In an exemplary embodiment, the composition is injected on a continuous basis through a downhole capillary string or umbilical.

In one exemplary embodiment, the methods comprise applying the composition into the annulus between the tubing and casing, where it can flow through the pump and into the tubing. In preferred embodiments, the treatment can produce effects in less than 24 hours of shut-in time.

In another exemplary embodiment, following the application of the composition to a well, the subject treatment can be applied into the annulus between the tubing and casing, where it can then be displaced into the pores of the formation. The volume of treatment used can be determined taking into account, for example, crude oil volume, formation porosity, permeability and thickness.

In some embodiments, brine fluids can be injected into a formation after the subject compositions in order to push the treatment deeper into the formation.

In addition to oil wells and associated equipment, it is often desirable to introduce the composition through perforations in the casing, into the surrounding formation. The composition may be forced into the surrounding formation by applied pressure or, if the composition is allowed to set at the bottom of the casing, the composition may seep into the formation without additional pressure. In specific embodiments, the composition permeates the formation, dissolving blockages in the formation to provide more efficient oil and gas recovery.

In one embodiment, the composition is poured or injected down the casing side (back lines) of a well and allowed to mix with the fluid that is already in the well. When enough fluid is present, the composition can then, optionally, be circulated by, for example, a pump for 24-72 hours, preferably 48-72 hours. Prior to circulating, the composition may be allowed to set for 8 to 24 hours, for example. The setting time, circulating time and dosage depend on, for example, the amount of scale anticipated to be present, as well as the depth and size of the well.

In one embodiment, the composition may be introduced by means of injection pumps into off-shore gas or oil wells to prevent scale flocculation, precipitation and/or deposition in well casings and transmission lines.

Advantageously, the compositions and methods of the subject invention are useful even when applied in the presence of water and/or in conditions that facilitate precipitation of scale.

In some embodiments, the methods can utilize compositions that are customized for a particular type of oil, oil well, or equipment. Thus, in one embodiment, the method comprises testing the oil, oil well and/or associated equipment, analyzing the scale compositions present therein and determining the preferred formulation for the composition prior to treatment.

In one embodiment, the subject methods can be used alongside and/or to enhance or supplement other methods of scale inhibition and/or dispersal, and/or enhanced oil recovery, e.g., other microbial, mechanical, thermal and/or chemical treatments.

In one embodiment, the subject invention can be used to improve one or more qualities of crude oil. For example, in one embodiment, the methods can be used to reduce the sulfide content (e.g., the sourness) of crude oil.

In some embodiments, the subject compositions and methods can also be useful for enhancing oil recovery due to, for example, the amphiphilic properties of, for example, glycolipid biosurfactants.

In one embodiment, the subject methods can alter the wettability of formation rock so that it is water-wet. Thus, the subject methods can be used to remediate formation “skin damage.” Skin damage is an occurrence characterized by a zone of reduced permeability within the vicinity of the wellbore. The reduction in permeability can be a result of, for example, deposits, such as asphaltenes, paraffins, scales and bacterial biofilms, as well as alterations in the wettability of formation rock from water-wet to oil-wet due to, for example, contaminating deposits, oil-based drilling fluids, and the use of BTEX solvents.

The subject treatment can be effective in a range of different geologic formations. For example, the subject invention can be useful in formations as deep as about 7,000 feet or deeper, and as shallow as about 1,500 feet or shallower. Additionally, the invention can be useful in formations having ranges of porosity and/or permeability, for example from about 0.1% to about 20% or more.

In certain embodiments, the subject compositions and methods are used for improving, enhancing, and/or maintaining operation of structures and equipment used for oil and gas production, transmission, storage, transportation, refining and/or processing. Such equipment can include, for example, subterranean oil- and/or gas-bearing formations, wells, well casings, boreholes, tubes, pipes, pumps, drills, tanks, pumps, rods, lines and the like. It is contemplated that the present invention may be used with all such structures and equipment, as well as others related thereto.

In one embodiment, the methods of the subject invention can be used for preventing corrosion associated with rust deposits, which can develop underneath scale deposits. In one embodiment, the methods are used for maintaining storage or transportation tanks that hold crude oil, brine fluids and/or produced water.

In additional embodiments, the composition of the subject invention may be applied directly to equipment. For example, prior to placing rods and casings into gas and/or oil wells, these parts may be sprayed with, or soaked in, the composition. The parts may be dipped into tanks filled with the composition to prevent corrosion and buildup of scale.

### Additional Considerations

In certain embodiments, the method comprises applying the composition with one or more further additives. Up to, for example, 50 wt. % or more of further additives may be applied, as needed, for particular applications, such as to vary the VOC levels, increase penetration of the mixture, decrease viscosity of the mixture, and/or as couplers for solvent insolubles in the mixture.

Suitable additives include, but are not limited to, alcohol ethoxylates, ethoxysulfates, C8-C14 alcohol ester blends, glycols, glycol ethers, acid esters, diacid esters, petroleum hydrocarbons, amino acids, alkanolamines, amines, methyl or isobutyl esters of C4-C6 aliphatic dibasic esters and n-methyl-2 pyrolidone.

C8-C14 alcohol ester blends include EXXATE 900, 1000, 1200 from Exxon Chemical; glycols include propylene glycol, dipropylene glycol, and triproplylene glycol; and glycol ethers include dipropylene glycol monomethyl ether, propylene glycol monomethyl ether, propylene glycol-n-butyl ether, ethylene glycol monobutyl ether, and diethylene glycol monobutyl ether. Acid esters include methyl oleate and methyl linoleate, and diacid esters include methyl or butyl diesters of glutaric, adipic, and succinic acids. Petroleum hydrocarbons include AROMATIC 100, AROMATIC 150 ISOPAR M, and ISOPAR K.

Amines such as morpholine; 1,3-dimethyl-2-imidazolidinone; 1, 3-propanediamine; 2-amino-1,3-propanediol; and 3-amino propanol; as well as alkanolamines such as triethanolamine, diethanolamine, 2-aminomethyl propanol, and monoethanolamine act as dispersants for contaminants and solubilize fatty acids and oils. Amino acids, provide nontoxic alternatives to monoethanolamine, and act as metal chelators. Methyl or isobutylesters of C4-C6 aliphatic dibasic esters and n-methyl-2 pyrolidone are also useful.

All additives should have a flash point greater than 100° F., preferably greater than 150° F. and more preferably 195° F. TCC in order to achieve a final product flash point greater than 200° F.

In one embodiment, the subject compositions and methods can be used alongside and/or to enhance or supplement other compositions and methods for scale inhibition, dispersion, and/or removal, as well as other methods for enhanced oil recovery, e.g., other microbial, mechanical, thermal and/or chemical treatments.

In some embodiments, the composition can be used alongside and/or formulated with known scale inhibitors, for example, phosphonates, phosphate esters and/or polyacrylates.

In some embodiments, the methods can comprise applying the composition alongside a non-biological surfactant.

Surfactants are surface active agents having two functional groups, namely a hydrophilic (water-soluble) or polar group and a hydrophobic (oil-soluble) or non-polar group. The hydrophobic group is usually a long hydrocarbon chain (C8-C18), which may or may not be branched, while the hydrophilic group is formed by moieties such as carboxylates, sulfates, sulfonates (anionic), alcohols, polyoxyethylenated chains (nonionic) and quaternary ammonium salts (cationic).

Surfactants are surface active agents having two functional groups, namely a hydrophilic (water-soluble) or polar group and a hydrophobic (oil-soluble) or non-polar group. The hydrophobic group is usually a long hydrocarbon chain (C8-C18), which may or may not be branched, while the hydrophilic group is formed by moieties such as carboxylates, sulfates, sulfonates (anionic), alcohols, polyoxyethylenated chains (nonionic) and quaternary ammonium salts (cationic).

Non-biological surfactants according to the subject compositions and methods include, but are not limited to: ethoxylated nonyl phenol phosphate esters, alkyl glucoside, alkyl phosphonium chloride, alkyl phosphonate surfactants, linear alcohols, nonylphenol compounds, quaternary amine, alkyoxylated fatty acids, alkylphenol alkoxylates, ethoxylated amides, methyl ester sulfonates, hydrolyzed keratin, sulfosuccinates, taurates, trimethyltallowammonium chloride, trimethylcocoammonium chloride, quaternary alkyl ammonium chloride, propargyl alcohol, acetylenic alcohol, phosphate esters, imidazolines, amine salts, amide salts, amine oxides, alkoxylated alcohols, lauryl alcohol ethoxylate, ethoxylated nonyl phenol, ethoxylated fatty amines, ethoxylated alkyl amines, cocoalkylamine ethoxylate, modified betaines, alkylamidobetaines, cocoamidopropyl betaine, sulfonated olefins, anionic surfactants, ammonium lauryl sulfate, sodium lauryl sulfate (also called SDS, sodium dodecyl sulfate), alkyl-ether sulfates sodium laureth sulfate (also known as sodium lauryl ether sulfate (SLES)), sodium myreth sulfate; docusates, dioctyl sodium sulfosuccinate, perfluorooctanesulfonate (PFOS), perfluorobutanesulfonate, linear alkylbenzene sulfonates (LABs), alkyl-aryl ether phosphates, alkyl ether phosphate; carboxylates, alkyl carboxylates (soaps), sodium stearate, sodium lauroyl sarcosinate, carboxylate-based fluorosurfactants, perfluorononanoate, perfluorooctanoate; cationic surfactants, pH-dependent primary, secondary, or tertiary amines, octenidine dihydrochloride, permanently charged quaternary ammonium cations, alkyltrimethylammonium salts, cetyl trimethylammonium bromide (CTAB) (a.k.a. hexadecyl trimethyl ammonium bromide), cetyl trimethylammonium chloride (CTAC), cetylpyridinium chloride (CPC), benzalkonium chloride (BAC), benzethonium chloride (BZT), 5-Bromo-5-nitro-1,3-dioxane, dimethyldioctadecylammonium chloride, cetrimonium bromide, dioctadecyldi-methylammonium bromide (DODAB); zwitterionic (amphoteric) surfactants, sultaines CHAPS (3-[(3-Cholamidopropyl)dimethylammonio]-1-propanesulfonate), cocamidopropyl hydroxysultaine, betaines, cocamidopropyl betaine, phosphatidylserine, phosphatidylethanolamine, phosphatidylcholine, sphingomyelins; nonionic surfactants, ethoxylate, long chain alcohols, fatty alcohols, cetyl alcohol, stearyl alcohol, cetostearyl alcohol, oleyl alcohol, polyoxyethylene glycol alkyl ethers (Brij): CH3-(CH2)10-16-(O—C2H4)1-25-OH (octaethylene glycol monododecyl ether, pentaethylene glycol monododecyl ether), polyoxypropylene glycol alkyl ethers: CH3-(CH2)10-16-(O—C3H6)1-25-OH, glucoside alkyl ethers: CH3-(CH2)10-16-(O-Glucoside)1-3-OH (decyl glucoside, lauryl glucoside, octyl glucoside), polyoxyethylene glycol octylphenol ethers: C8H17—(C6H4)—(O—C2H4)1-25-OH (Triton X-100), polyoxyethylene glycol alkylphenol ethers: C9H19-(C6H4)—(O—C2H4)1-25-OH (nonoxynol-9), glycerol alkyl esters (glyceryl laurate), polyoxyethylene glycol sorbitan alkyl esters (polysorbate), sorbitan alkyl esters (spans), cocamide MEA, cocamide DEA, dodecyldimethylamine oxide, copolymers of polyethylene glycol and polypropylene glycol (poloxamers), and polyethoxylated tallow amine (POEA).

Anionic surfactants contain anionic functional groups at their head, such as sulfate, sulfonate, phosphate, and carboxylates. Prominent alkyl sulfates include ammonium lauryl sulfate, sodium lauryl sulfate (also called SDS, sodium dodecyl sulfate) and the related alkyl-ether sulfates sodium laureth sulfate, also known as sodium lauryl ether sulfate (SLES), and sodium myreth sulfate. Carboxylates are the most common surfactants and comprise the alkyl carboxylates (soaps), such as sodium stearate.

Surfactants with cationic head groups include: pH-dependent primary, secondary, or tertiary amines; octenidine dihydrochloride; permanently charged quaternary ammonium cations such as alkyltrimethylammonium salts: cetyl trimethylammonium bromide (CTAB) a.k.a. hexadecyl trimethyl ammonium bromide, cetyl trimethylammonium chloride (CTAC); cetylpyridinium chloride (CPC); benzalkonium chloride (BAC); benzethonium chloride (BZT); 5-Bromo-5-nitro-1,3-dioxane; dimethyldioctadecylammonium chloride; cetrimonium bromide; and dioctadecyldi-methylammonium bromide (DODAB).

Zwitterionic (amphoteric) surfactants have both cationic and anionic centers attached to the same molecule. The cationic part is based on primary, secondary, or tertiary amines or quaternary ammonium cations. The anionic part can be more variable and include sulfonates. Zwitterionic surfactants commonly have a phosphate anion with an amine or ammonium, such as is found in the phospholipids phosphatidylserine, phosphatidylethanolamine, phosphatidylcholine, and sphingomyelins.

A surfactant with a non-charged hydrophilic part, e.g., ethoxylate, is non-ionic. Many long chain alcohols exhibit some surfactant properties.

Other suitable additives include, for example, emulsifying agents, demulsifiers, lubricants, buffering agents, solubility controlling agents, pH adjusting agents, preservatives and, stabilizers.

### Production of Microbe-Based Products

In one embodiment, the subject invention provides methods of producing a microbial metabolite by cultivating a microbe under conditions appropriate for growth and production of the metabolite; and, optionally, purifying the metabolite. In a specific embodiment, the metabolite is a biosurfactant. The metabolite may also be, for example, ethanol, lactic acid, beta-glucan, proteins, amino acids, peptides, metabolic intermediates, polyunsaturated fatty acids, and lipids. The metabolite content produced by the method can be, for example, at least 20%, 30%, 40%, 50%, 60%, 70%, 80%, or 90%.

The microorganisms utilized according to the subject invention may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In certain embodiments, the microbes are capable of producing amphiphilic molecules, enzymes, proteins and/or biopolymers. Microbial biosurfactants, in particular, are produced by a variety of microorganisms such as bacteria, fungi, and yeasts, including, for example, Agrobacterium spp. (e.g., A. radiobacter); Arthrobacter spp.; Aspergillus spp.; Aureobasidium spp. (e.g., A. pullulans); Azotobacter (e.g., A. vinelandii, A. chroococcum); Azospirillum spp. (e.g., A. brasiliensis); Bacillus spp. (e.g., B. subtilis, B. amyloliquefaciens, B. pumillus, B. cereus, B. licheniformis, B. firmus. B. laterosporus, B. megaterium, NRRL B-67928, NRRL B-68031, ATCC PTA-123459); Blakeslea; Candida spp. (e.g., C. albicans, C. rugosa, C. tropicalis, C. lipolytica, C. torulopsis); Clostridium (e.g., C. butyricum, C. tyrobutyricum, C. acetobutyricum, and C. beijerinckii); Campylobacter spp.; Cornybacterium spp.; Cryptococcus spp.; Debaryomyces spp. (e.g., D. hansenii); Entomophthora spp.; Flavobacterium spp.; Gordonia spp.; Hansenula spp.: Hanseniaspora spp. (e.g., H. uvarum); Issatchenkia spp; Kluyveromyces spp.; Meyerozyma spp. (e.g., M. guilliermondii); Mortierella spp.; Mycorrhiza spp.; Mycobacterium spp.; Nocardia spp.; Pichia spp. (e.g., P. anomala, P. guilliermondii, P. occidentalis, P. kudriavzevii); Phycomyces spp.; Phythium spp.; Pseudomonas spp. (e.g., P. aeruginosa, P. chlororaphis, P. putida, P. florescens, P. fragi, P. syringae); Pseudozyma spp. (e.g., P. aphidis); Ralslonia spp. (e.g., R. eulropha); Rhodococcus spp. (e.g., R. erythropolis); Rhodospirillum spp. (e.g., R. rubrum); Rhizobium spp.; Rhizopus spp.; Saccharomyces spp. (e.g., S. cerevisiae, S. boulardii sequela, S. torula); Sphingomonas spp. (e.g., S. paucimobilis); Starmerella spp. (e.g., S. bombicola); Thraustochytrium spp.; Torulopsis spp.; Ustilago spp. (e.g., U. maydis); Wickerhamomyces spp. (e.g., W. anomalus, NRRL Y-68030); Williopsis spp.; and/or Zygosaccharomyces spp. (e.g., Z. bailii).

In certain embodiments, the microorganism is a Starmerella spp. yeast and/or Candida spp. yeast, e.g., Starmerella (Candida) bombicola, Candida apicola, Candida batistae, Candida floricola, Candida riodocensis, Candida stellate and/or Candida kuoi. In a specific embodiment, the microorganism is Starmerella bombicola, e.g., strain ATCC 22214. These yeasts are known sophorolipid producers.

In certain embodiments, the microorganism is Burkholderia thailandensis or a Pseudomonas spp. bacterium, such as, e.g., P. aeruginosa, P. chlororaphis, P. plantarii, P. putida or P. fluorescens.

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, agitator shaft power, humidity, viscosity and/or microbial density and/or metabolite concentration.

In a further embodiment, the vessel may also be able to monitor the growth of microorganisms inside the vessel (e.g., measurement of cell number and growth phases). Alternatively, samples may be taken from the vessel for enumeration, purity measurements, biosurfactant concentration, and/or visible oil level monitoring. For example, in one embodiment, sampling can occur every 24 hours.

The microbial inoculant according to the subject methods preferably comprises cells and/or propagules of the desired microorganism, which can be prepared using any known fermentation method. The inoculant can be pre-mixed with water and/or a liquid growth medium, if desired.

In certain embodiments, the cultivation method utilizes submerged fermentation in a liquid growth medium. In one embodiment, the liquid growth medium comprises a carbon source. The carbon source can be a carbohydrate, such as glucose, dextrose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as canola oil, soybean oil, rice bran oil, olive oil, corn oil, sunflower oil, sesame oil, and/or linseed oil; powdered molasses, etc. These carbon sources may be used independently or in a combination of two or more. In preferred embodiments, a hydrophilic carbon source, e.g., glucose, and a hydrophobic carbon source, e.g., oil or fatty acids, are used.

In some embodiments, the cultivation method utilizes reduced amounts of a carbon source, compared with standard methods in the art. For example, in some embodiments, the liquid growth medium can comprise a sugar (e.g., glucose) and an oil (e.g., canola oil) at amounts of 25-70 g/L and 25-70 ml/L, respectively. Advantageously, in some embodiments, reducing the amount of sugar and oil in the liquid growth medium reduces the amount of glucose and/or oil impurities left in the culture, thus enhancing the ability to purify the SLP molecules to greater degrees of purity.

In one embodiment, the liquid growth medium comprises a nitrogen source. The nitrogen source can be, for example, yeast extract, potassium nitrate, ammonium nitrate, ammonium sulfate, ammonium phosphate, ammonia, urea, and/or ammonium chloride. These nitrogen sources may be used independently or in a combination of two or more.

In one embodiment, one or more inorganic salts may also be included in the liquid growth medium. Inorganic salts can include, for example, potassium dihydrogen phosphate, monopotassium phosphate, dipotassium hydrogen phosphate, disodium hydrogen phosphate, potassium chloride, magnesium sulfate, magnesium chloride, iron sulfate, iron chloride, manganese sulfate, manganese chloride, zinc sulfate, lead chloride, copper sulfate, calcium chloride, calcium carbonate, calcium nitrate, magnesium sulfate, sodium phosphate, sodium chloride, and/or sodium carbonate. These inorganic salts may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, proteins and microelements can be included, for example, corn flour, peptone, yeast extract, potato extract, beef extract, soybean extract, banana peel extract, and the like, or in purified forms. Amino acids such as, for example, those useful for biosynthesis of proteins, can also be included.

The method of cultivation can further provide oxygenation to the growing culture. One embodiment utilizes slow motion of air to remove low-oxygen containing air and introduce oxygenated air. The oxygenated air may be ambient air supplemented daily through mechanisms including impellers for mechanical agitation of the liquid, and air spargers for supplying bubbles of gas to the liquid for dissolution of oxygen into the liquid. In certain embodiments, dissolved oxygen (DO) levels are maintained at about 25% to about 75%, about 30% to about 70%, about 35% to about 65%, about 40% to about 60%, or about 50% of air saturation.

In some embodiments, the method for cultivation may further comprise adding additional acids and/or antimicrobials in the liquid medium before and/or during the cultivation process. Antimicrobial agents or antibiotics (e.g., streptomycin, oxytetracycline) are used for protecting the culture against contamination. In some embodiments, however, the metabolites produced by the yeast culture provide sufficient antimicrobial effects to prevent contamination of the culture.

In one embodiment, prior to inoculation, the components of the liquid culture medium can optionally be sterilized. In one embodiment, sterilization of the liquid growth medium can be achieved by placing the components of the liquid culture medium in water at a temperature of about 85-100° C. In one embodiment, sterilization can be achieved by dissolving the components in 1 to 3% hydrogen peroxide in a ratio of 1:3 (w/v).

In one embodiment, the equipment used for cultivation is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Gaskets, openings, tubing and other equipment parts can be sprayed with, for example, isopropyl alcohol. Air can be sterilized by methods know in the art. For example, the ambient air can pass through at least one filter before being introduced into the vessel. In other embodiments, the medium may be pasteurized or, optionally, no heat at all added, where the use of pH and/or low water activity may be exploited to control unwanted microbial growth.

The pH of the culture should be suitable for the microorganism of interest. In some embodiments, the pH is about 2.0 to about 7.0, about 3.0 to about 5.5, about 3.25 to about 4.0, or about 3.5. Buffers, and pH regulators, such as carbonates and phosphates, may be used to stabilize pH near a preferred value. In certain embodiments, a base solution is used to adjust the pH of the culture to a favorable level, for example, a 15% to 30%, or a 20% to 25% NaOH solution. The base solution can be included in the growth medium and/or it can be fed into the fermentation reactor during cultivation to adjust the pH as needed.

In one embodiment, the method of cultivation is carried out at about 5° to about 100° C., about 15° to about 60° C., about 20° to about 45° C., about 22° to about 35° C., or about 24° to about 28° C. In one embodiment, the cultivation may be carried out continuously at a constant temperature. In another embodiment, the cultivation may be subject to changing temperatures.

According to the subject methods, the microorganisms can be incubated in the fermentation system for a time period sufficient to achieve a desired effect, e.g., production of a desired amount of cell biomass or a desired amount of one or more microbial growth by-products. The microbial growth by-product(s) produced by microorganisms may be retained in the microorganisms and/or secreted into the growth medium. The biomass content may be, for example from 5 g/l to 180 g/l or more, or from 10 g/l to 150 g/l.

In certain embodiments, fermentation of the microbial culture occurs for about 100 to 150 hours, or about 115 to about 125 hours, or about 120 hours. The biosurfactants resulting from cultivation can be extracted and, optionally purified. Alternatively, the broth containing the biosurfactant and residual products of fermentation, including live, inactive and/or lysed microorganisms can be present.

### EXAMPLES

A greater understanding of the present invention and of its many advantages may be had from the following examples, given by way of illustration. The following examples are illustrative of some of the methods, applications, embodiments and variants of the present invention. They are not to be considered as limiting the invention. Numerous changes and modifications can be made with respect to the invention.

### Example 1—Surfactant Trials

Lab-made iron or zinc sulfide scale were obtained by reaction of sodium sulfide with iron (II) chloride or zinc chloride. All sulfide scale precipitation and dispersion stability testing were conducted under semi-anaerobic conditions where possible, but oxidation could not be totally prevented.

Field deposits of sulfide scales were provided by independent oil and gas operators in the United States and characterized for compositional analysis and morphology. Several iron sulfide samples were also collected from produced water samples by separation methods. Natural pyrite cube samples were obtained from a mineral supplier.

Two glycolipids biosurfactant blends and a non-ionic synthetic surfactant were used in the study. FIG. 2. The sophorolipids comprised a mixture of three different linear sophorolipids, having differing degrees of saturation in the fatty acid moiety. The rhamnolipids comprised a mixture of mono- and di-rhamnolipids. Triton X-100 is an alkyl phenyl ethoxylate with an average of 9.5 ethylene oxide.

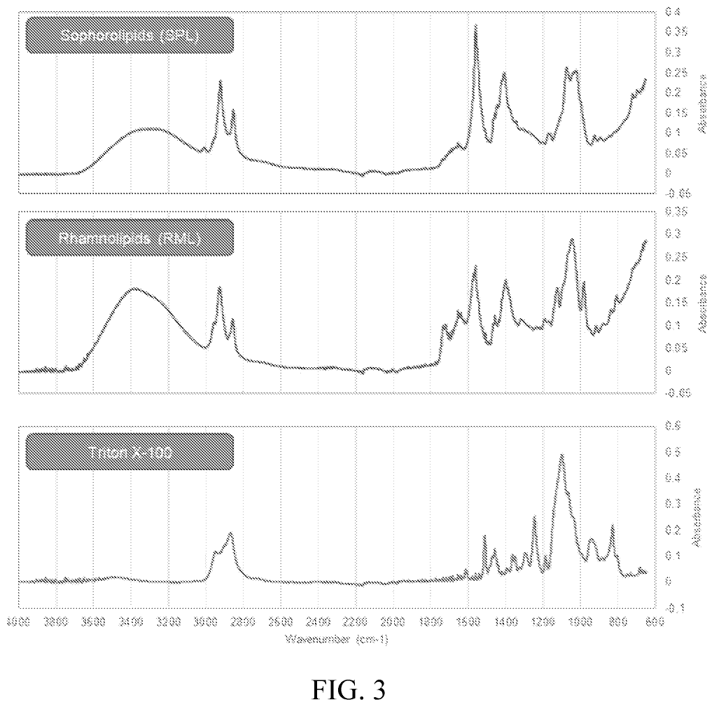

Surface and interfacial tension behavior of biosurfactants were measured using a drop shape tensiometer. Static and dynamic surface tension of surfactant solutions were measured using a force tensiometer (ring method) or bubble pressure tensiometer, respectively. Accelerated dispersion instability of metal sulfide particulates in surfactant solutions were assessed using a centrifugal sedimentation method on a LUMiSizer (LUM GmbH, Germany) at 25° C. Instability indexes were calculated from evolution of transmission profiles recorded in intervals of 10 seconds and used to determine efficiency of surfactants for dispersing lab-made and field samples of iron and zinc sulfides. FTIR-ATR and UV-vis spectroscopy were used to determine mode of interaction of surfactant with metal sulfide surfaces. FTIR spectra of Triton-X-100 as neat and sophorolipids (SPL) and rhamnolipids (RML) after removing solvents were obtained (FIG. 3) and used for reference.

### Results

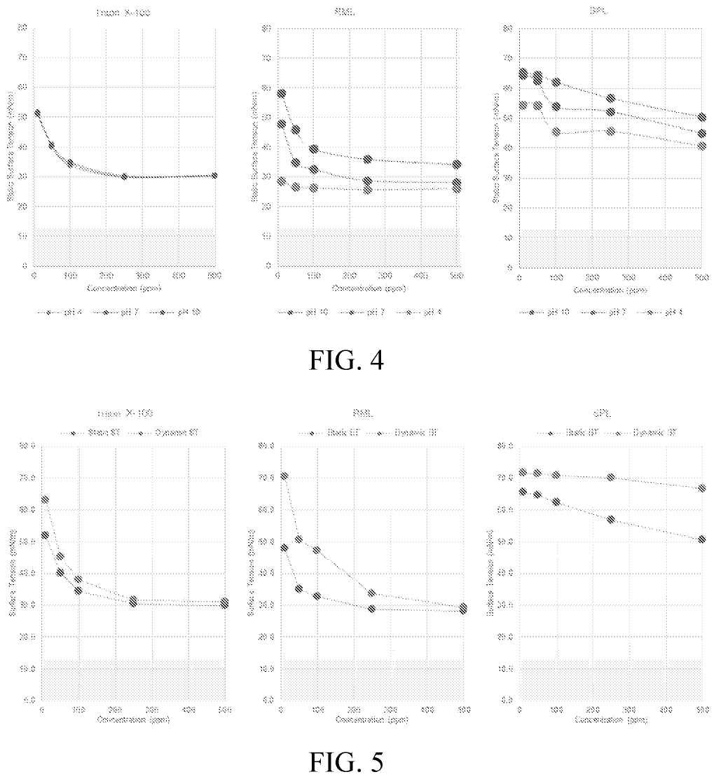

Efficacy of surfactant chemistries for reducing surface tension of water was evaluated using the ring method on a force tensiometer at pH 4, 7 and 10. FIG. 4 presents static surface tension as a function of surfactant concentration (active) from 10 to 500 ppm. Triton X-100 can reduce surface tension down to 30.3 mN/m at 250 ppm concentration and its performance is independent of media pH. The rhamnolipids can reduce surface tension to 26.7 mN/m at 50 ppm concentration, but their surface reduction property is pH sensitive and an increase in surface tension was observed as pH increased from 4 to 7 and 10. The sophorolipids pose very different and complex behavior for surface tension as a function of pH. Highest surface tension reduction was measured at pH 4, and lowest reduction was measured at pH 7.

The process of surface tension reduction by surfactant adsorption is not instantaneous and is generally diffusion-controlled. After sufficient adsorption time, the static or equilibrium surface tension will be reached. The dynamic or nonequilibrium surface tension is the relevant surface tension acting during fast processes.

A bubble pressure tensiometer was used to determine dynamic surface tension of surfactant solutions. A comparison of static and dynamic surface tension of surfactants in media at pH 7 was made. FIG. 5. Dynamic and static surface tension reduction for Triton X-100 was found to be equivalent at higher surfactant concentrations, but both the rhamnolipid and sophorolipid biosurfactants show very different characteristics under nonequilibrium conditions with sophorolipids being least effective on reducing dynamic surface tension at air-water interface.

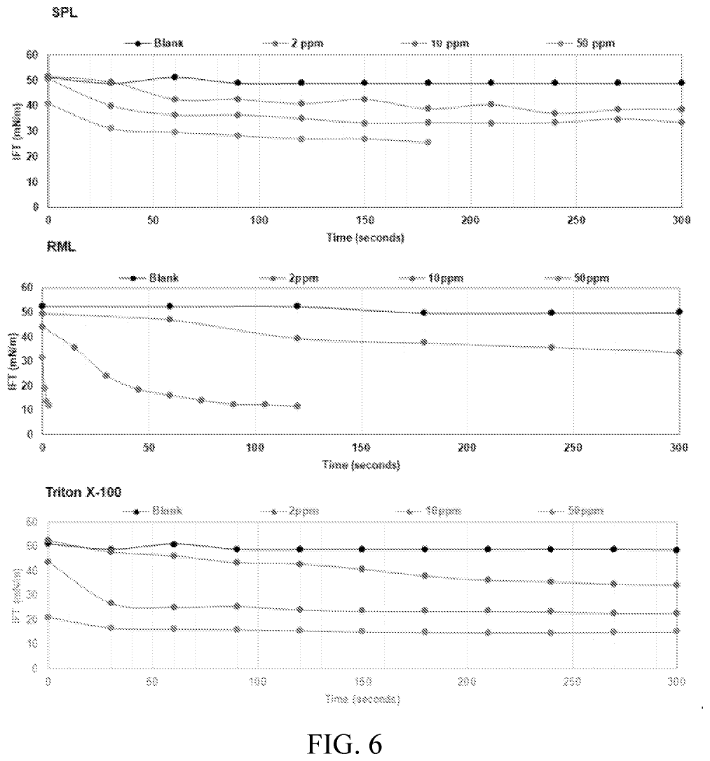

Interfacial properties of Triton X-100 and biosurfactants were evaluated using a distilled water-dodecane system. Interfacial tension (IFT) of oil-water was measured by drop shape analysis using an optical tensiometer at ambient temperature. FIG. 6. All chemistries demonstrated IFT reduction at concentration range from 2 to 50 ppm with the rhamnolipids being highly effective at both 10 and 50 ppm, resulting in faster detachment of the oil droplet from the tip of the needle. The sophorolipids offer more desirable interfacial characteristics than Triton X-100 because the oil droplet departed after 180 seconds at 50 ppm concentration, while the droplet did not detach during 300 second measurement in the Triton solution.

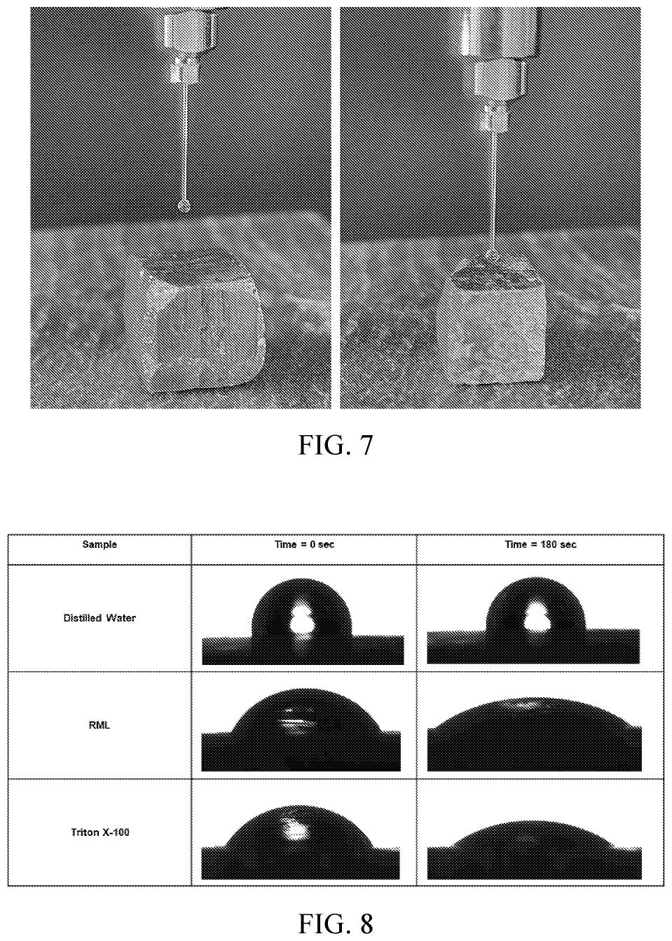

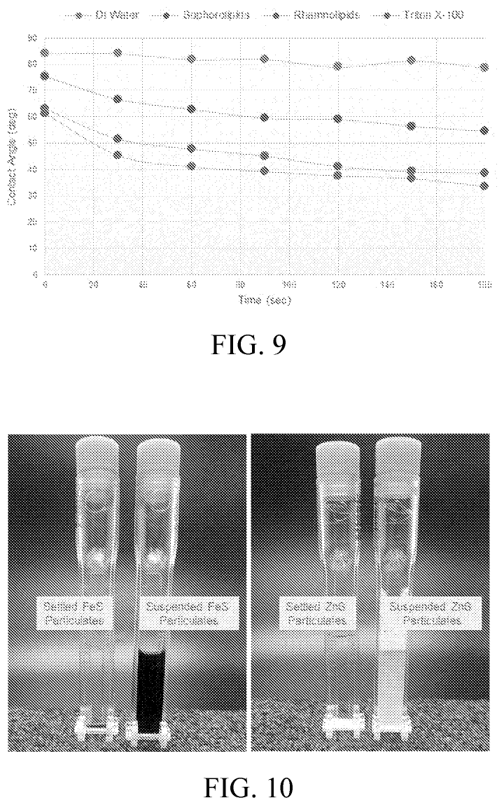

The wettability characteristics of natural pyrite cubes were studied by contact angle measurements to assess surfactant chemistries. Pyrite was used as a representative metal sulfide surface for evaluating surface hydrophobicity and hydrophilicity in the presence of surfactants in aqueous solutions. All measurements were done using sessile drop method on an optical tensiometer at ambient temperature. FIGS. 7-8 show the experimental setup and captured images from the water droplet on the surface of the pyrite cube. Measurements were done in triplicate and average contact angle data recorded at intervals of 30 seconds from the time the droplet was placed on the surface. All chemistries demonstrated water wetting properties against the oil-wet surface of pyrite, with Triton X-100 and rhamnolipids turning the surface more hydrophilic compared to the sophorolipids.

Dispersion properties of surfactant chemistries were assessed using a LUMiSizer®, which accelerates the occurrence of destabilization and settling of suspended solids by applying centrifugal force. Iron sulfide and zinc sulfide particulates were freshly prepared by precipitated using zinc chloride or iron (II) chloride with sodium sulfide aqueous solutions at a ratio of 2:1 mmol respectively. FIG. 10 presents the comparison of completely settled versus suspended FeS or ZnS particulates in water within the experimental cells.

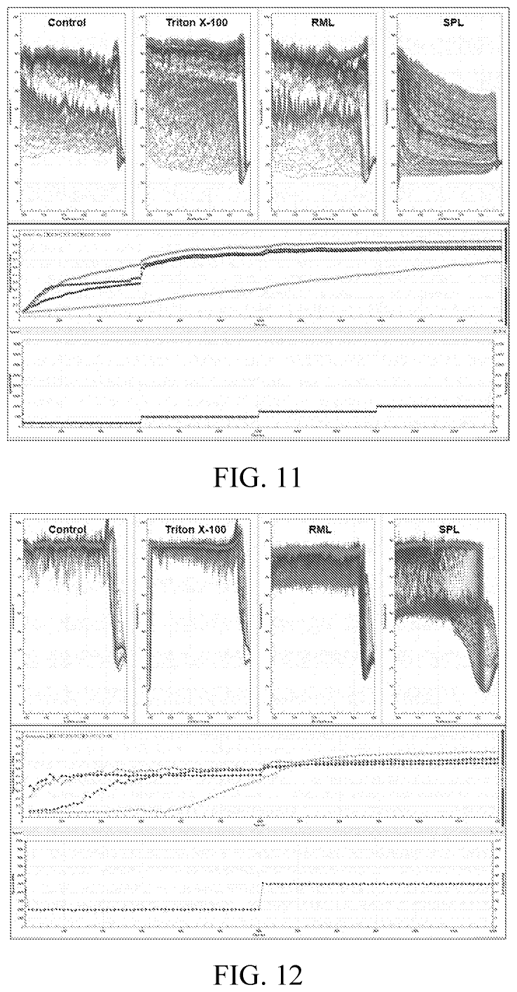

Transmission profiles were recorded for horizontally placed cells containing freshly prepared suspension of sulfide solids into the instrument and exposed to centrifugal force for a period of 10 minutes at a given rotor speed of 250, 500, 750 or 1000 rpm at 25° C. Separation indexes were calculated using SEPView® software. Evolution of transmission profiles and separation indices for FeS and ZnS suspensions in distilled water (Control) and surfactant solutions (250 ppm) are shown in FIGS. 11 and 12, respectively.

Results from accelerated dispersion instability analysis clearly revealed the efficacy of sophorolipids in suspending FeS particulates under centrifugal force up to 1000 rpm. Surprisingly, Triton X-100 and rhamnolipids demonstrated no efficacy in dispersing iron sulfides. Similar results were obtained under statis sedimentation conditions. For ZnS particulates, both the rhamnolipids and the sophorolipids showed dispersion characteristics under static settling and at lower centrifugal force but increasing centrifugation to 500 rpm resulted in complete settlement of particulates. Under the same conditions, Triton X-100 demonstrated no efficacy for suspending ZnS fines.

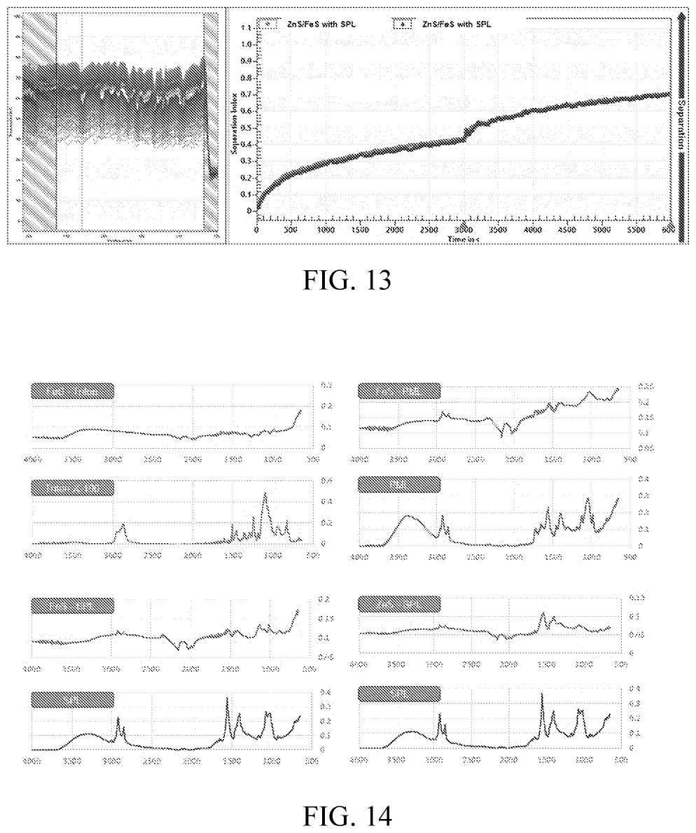

The performance of the sophorolipids, for remediation of field deposits of metal sulfides, was demonstrated using a solid sample collected from electric submersible pump (ESP) failure workover job. X-ray fluorescence (XRF) analysis, provided the composition of deposit being 86% ZnS, 12% FeS and traces of calcium carbonate and quartz. A suspension of deposit was obtained by redispersion in an aqueous solution containing 5000 ppm of the sophorolipids using sonication and heating at 50° C. for 30 min. Supernatant was transferred into a LUMiSizer cell and separation index was monitored at both 500 and 1000 rpm centrifugal force. FIG. 13.

FTIR-ATR and UV-vis spectroscopy were utilized to find modes of interaction of biosurfactant active sites with metal sulfide surfaces. Fresh samples of FeS and ZnS were prepared from mixing metal chlorides and sodium sulfide in the presence of surfactant chemistries. Precipitates were isolated and analyzed by FTIR technique for residual surfactants adsorbed onto sulfides surfaces. FTIR Spectra as shown in FIG. 14, revealed no trace of Triton X-100 on the surface of FeS, but traces of both rhamnolipids and sophorolipids adsorbed on the surface of metal sulfide could be detected from FTIR spectra.

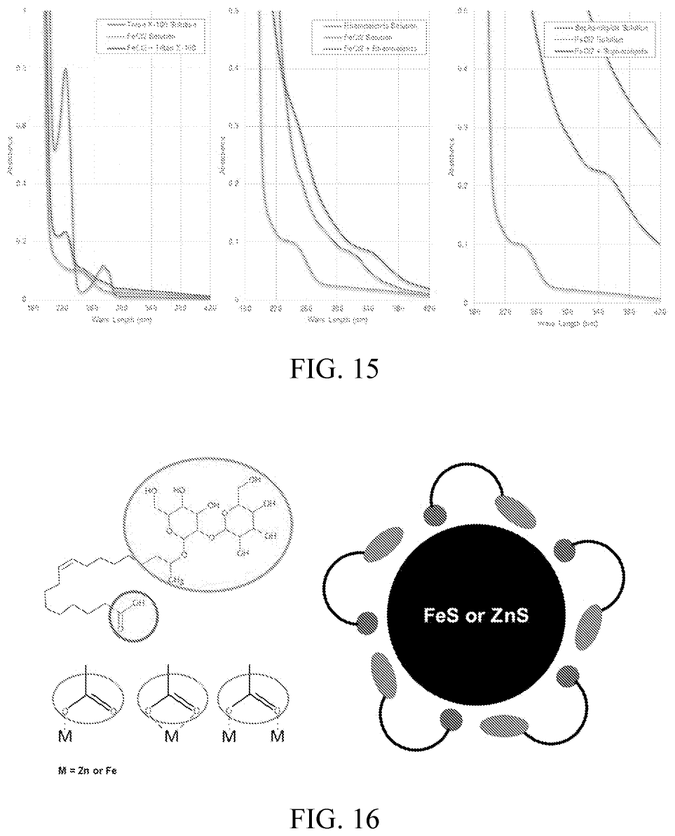

Potential interaction of biosurfactants with iron (ii) ions through metal ion coordination with carboxylate groups present in both rhamnolipid and sophorolipid molecules was also studied. If a strong interaction exists between metal ions and surfactant, it will impact the characteristic UV-vis absorption profile of iron (II) ions. A strong interaction between Fe(II) and sophorolipids was observed, followed by rhamnolipids, but no changes observed for Triton X-100. FIG. 15.

The results show that the interactions of rhamnolipids and sophorolipids with iron and zinc sulfide surfaces result in a tendency to engage with sulfide scale during and after nucleation, as well as growth resulting in stabilizing dispersions. Linear sophorolipids exhibit a unique and stronger interaction with both iron and zinc sulfides as demonstrated in FIG. 16. Rhamnolipids, on the other hand, were found to be more effective in reducing surface and interfacial tension at low concentrations. Both groups of biosurfactants offer very interesting properties to be used as synergist in developing new products for sulfide scale control.

### REFERENCES

Hamza, A., Hussein, I. A., Jalab, R., Saad, M., and Mohamoud, M. (2021). “Review of Iron Sulfide Scale Removal and Inhibition in Oil and Gas Wells: Current Status and Perspectives”. Energy & Fuels, 35, 14401-14421 (https://doi.org/10.1021/acs.energyfuels.1c02177)
Hayes, D. H., Solaiman, D. K. Y., Ashby, R. D. Editors. “Biobased Surfactants: Synthesis, Properties and Applications”. (2019), 2nd Edition, (https://doi.org/10.1016/C2016-O-03179-0)

We claim:

1. A method for enhancing oil recovery from an oil production environment having scale deposits and/or scale ions therein, the method comprising applying a composition comprising one or more microbial biosurfactants to the oil production environment such that the composition contacts the scale deposits and/or scale ions, wherein the composition inhibits the formation of scale deposition on surfaces in the oil production environment and/or wherein the composition removes scale deposits that are present on the surfaces.

2. The method of claim 1, wherein the scale is zinc sulfide or ion sulfide scale.

3. The method of claim 1, wherein the composition comprises one or more glycolipid biosurfactants.

4. The method of claim 3, wherein the glycolipid biosurfactants are linear sophorolipids, lactonic sophorolipids, or a mixture thereof.

5. The method of claim 4, wherein the sophorolipids have one or more of the following structures:

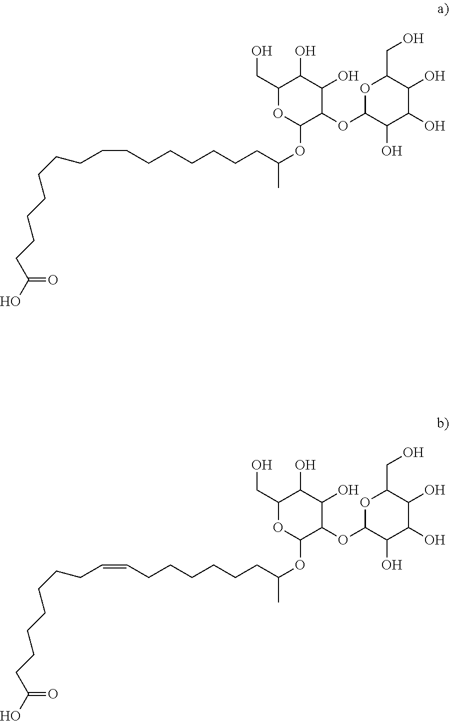 [SMILES: CC(CCCCCCCCCCCCCCCC(=O)O)OC1OC(CO)C(O)C(O)C1OC1OC(CO)C(O)C(O)C1O ; CC(CCCCCC/C=C\CCCCCCCC(=O)O)OC1OC(CO)C(O)C(O)C1OC1OC(CO)C(O)C(O)C1O]

6. The method of claim 3, wherein the rhamnolipids have one or more of the following structures:

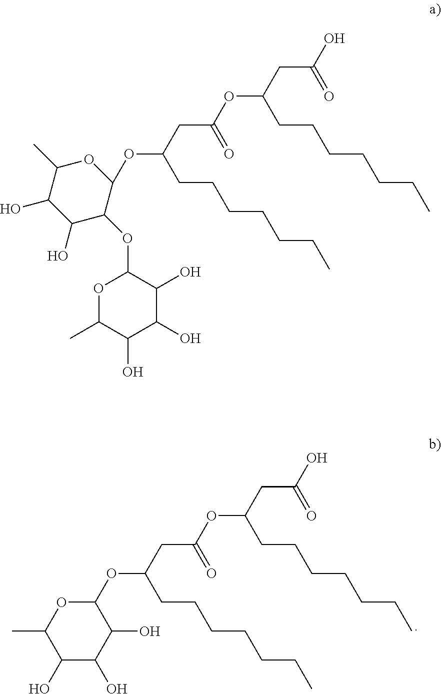

7. The method of claim 1, wherein the composition is applied to a fluid comprising scale ions, said fluid selected from crude oil fluid, a brine fluid, produced water, a frack fluid, and well treatment fluids, wherein the application of the composition disperses scale ions, reduces agglomeration of scale ions and/or reduces precipitation of scale crystals from the fluid.

8. The method of claim 1, wherein the composition is applied directly to a surface of equipment associated with oil production, processing, transportation, storage and/or refining selected from piping, tubing, pipelines, drills, pumps, valves and tanks, and wherein the application of the composition reduces the deposition of scale crystals thereon and/or removes scale deposits from the surface.

9. The method of claim 1, wherein the composition is injected into a subterranean formation as a continuous injection treatment, a batch treatment or a squeeze treatment.

10. The method of claim 1, used to improve the flow of oil and/or gas from a formation by opening pores, fractures, tubing and/or piping associated with the formation.

11. The method of claim 1, used to maintain equipment associated with oil production, processing, transportation, storage and/or refining.
